(19) United States
(12) Patent Application Publication
(10) Pub. No.: US 2018/0263101 A1
(43) Pub. Date: Sep. 13, 2018

(54) TARGET GENERATION DEVICE AND EUV LIGHT GENERATION DEVICE

(71) Applicant: Gigaphoton Inc., Tochigi (JP)

(72) Inventor: Takanobu ISHIHARA, Oyama-shi (JP)

(73) Assignee: Gigaphoton Inc., Tochigi (JP)

(21) Appl. No.: 15/976,593

(22) Filed: May 10, 2018

Related U.S. Application Data
(63) Continuation of application No. PCT/JP2015/084848, filed on Dec. 11, 2015.

(51) Int. Cl. H05G 2/00

(52) U.S. Cl. CPC H05G 2/006; H05G 2/008; H05G 2/005

(57) ABSTRACT

A target generation device includes a nozzle including a nozzle hole for discharging a target formed of molten metal in a chamber and a cylindrical member which is attached to the nozzle to surround the nozzle hole and has a substance, with standard free energy of formation of oxide smaller than that of the molten metal, exposed on at

### CROSS-REFERENCE TO RELATED APPLICATIONS

The present application is a continuation application of International Application No. PCT/JP2015/084848 filed on Dec. 11, 2015. The content of the application is incorporated herein by reference in its entirety.

### BACKGROUND

### 1. Technical Field

The present disclosure relates to a target generation device and an extreme ultraviolet light generation device.

### 2. Related Art

In recent years, according to miniaturization of a semiconductor process, miniaturization of transfer patterns in optical lithography of the semiconductor process has been rapidly progressed. In the next generation, microfabrication of equal to or less than 20 nm will be required. For this reason, development of an exposure apparatus formed by combining an apparatus to generate extreme ultraviolet (EUV) light with a wavelength of about 13 nm and a reduced projection reflective optics has been expected.

As an EUV light generation device, three kinds of apparatuses are proposed, i.e., a Laser Produced Plasma (LPP) type device using plasma generated by irradiating a target substance with a laser beam, a Discharge Produced Plasma (DPP) type device using plasma generated by discharge, and a Synchrotron Radiation (SR) type device using orbital synchrotron radiation.

### CITATION LIST

### Patent Literature

[Patent Literature 1] JP 2009-204927 A
[Patent Literature 2] JP 2012-179900 A
[Patent Literature 3] JP 2014-35948 A

### SUMMARY

A target generator according to one aspect of the present disclosure may include a nozzle and a cylindrical member. The nozzle may include a nozzle hole for discharging a target formed of molten metal in a chamber. The cylindrical member may be attached to the nozzle to surround the nozzle hole and have a substance, with standard free energy of formation of oxide smaller than the molten metal, which is exposed on at least a part of an inner wall surface.

An extreme ultraviolet light generation device according to one aspect of the present disclosure may include a nozzle, a cylindrical member, a laser apparatus, and a focusing mirror. The nozzle may include a nozzle hole for discharging a target formed of molten metal in a chamber. The cylindrical member may be attached to the nozzle to surround the nozzle hole and have a substance, with standard free energy of formation of oxide smaller than that of the molten metal, which is exposed on at least a part of an inner wall surface. The laser apparatus may irradiate the target output from the nozzle hole with a laser beam. The focusing mirror may collect and output extreme ultraviolet light emitted from plasma of the target generated by being irradiated with the laser beam.

### BRIEF DESCRIPTION OF THE DRAWINGS

Hereinafter, several embodiments of the present disclosure will be described with reference to the accompanying drawings as examples.

FIG. 1 is a diagram schematically illustrating a configuration of an exemplary LPP type EUV light generation system.

FIG. 2 is a schematic diagram illustrating an exemplary schematic configuration of an EUV light generation device according to a comparative example.

FIG. 3 is a graph illustrating a calculation result of an equilibrium partial pressure of oxygen (partial pressure of saturated oxygen) of tin in a case where it is assumed that an activity of tin and tin oxide is one.

FIG. 4 is a diagram illustrating exemplary tin oxide formed on a surface of tin contained in a tank in a temperature increasing period of tin.

FIG. 5 is a diagram illustrating exemplary tin oxide formed on the surface of tin in a standby period after the temperature of tin has been increased.

FIG. 6 is a diagram illustrating exemplary tin oxide formed on the surface of tin when tin is solidified by decreasing the temperature of tin which has been once molten.

FIG. 7 is a schematic diagram illustrating an exemplary schematic configuration of an EUV light generation device including a target generation device according to a first embodiment.

FIG. 8 is a cross sectional diagram illustrating an exemplary schematic configuration of a portion including a vicinity of a front end of a nozzle in FIG. 7.

FIG. 9 is a schematic diagram illustrating an exemplary schematic configuration of a portion including the vicinity of the front end of the nozzle in a case of viewing the nozzle toward a nozzle hole.

FIG. 10 is a conceptual diagram illustrating an exemplary relationship between standard free energy of formation and a temperature of a substance.

FIG. 11 is a conceptual diagram illustrating estimated partial pressures of oxygen at an opening at one end and an opening at the other end of a cylindrical main body illustrated in FIG. 8.

FIG. 12 is a cross sectional diagram illustrating an exemplary schematic configuration of a portion including a vicinity of a front end of a nozzle according to a second embodiment.

FIG. 13 is a schematic diagram illustrating an exemplary schematic configuration of the portion including the vicinity of the front end of the nozzle in a case of viewing the nozzle toward a nozzle hole.

FIG. 14 is a cross sectional diagram illustrating an exemplary schematic configuration of a portion including a vicinity of a front end of a nozzle according to a third embodiment.

FIG. 15 is a schematic diagram illustrating an exemplary schematic configuration of the portion including the vicinity of the front end of the nozzle in a case of viewing the nozzle toward a nozzle hole.

FIG. 16 is a cross sectional diagram illustrating an exemplary schematic configuration of a portion including a vicinity of a front end of a nozzle according to a fourth embodiment.

FIG. 17 is a schematic diagram illustrating an exemplary schematic configuration of the portion including the vicinity of the front end of the nozzle in a case of viewing the nozzle toward a nozzle hole.

### DETAILED DESCRIPTION

### 1. Overview

### 2. Overview of Extreme Ultraviolet Light Generation Device

2.1 Configuration

2.2 Operation

3. EUV Light Generation Device Including Target Generation Device: Comparative example

3.1 Configuration of Comparative Example

3.2 Operation of Comparative Example

3.3 Problems

### 4. First Embodiment

4.1 Configuration

4.2 Operation

4.3 Action and Effect

### 5. Second Embodiment

5.1 Configuration

5.2 Action and Effect

### 6. Third Embodiment

6.1 Configuration

6.2 Action and Effect

### 7. Fourth Embodiment

7.1 Configuration

7.2 Operation

7.3 Action and Effect

Hereinafter, embodiments of the present disclosure will be described in detail with reference to the drawings.

The embodiments to be described below are merely examples of the present disclosure and do not limit the scope of the present disclosure. Furthermore, all of the configurations and the operations described in the embodiments are not necessarily essential for the configurations and the operations of the present disclosure. The same components are denoted with the same reference numerals, and overlapped explanations will be omitted

### 1. Overview

Embodiments according to the present disclosure relate to a target generation device used for an EUV light generation device. The present disclosure relates to a target generation device and an extreme ultraviolet light generation device which can discharge a stable target by, for example, preventing formation of an oxide film on a molten metal to be a target exposed from a nozzle hole of a nozzle.

### 2. Overview of Extreme Ultraviolet Light Generation Device

### 2.1 Configuration

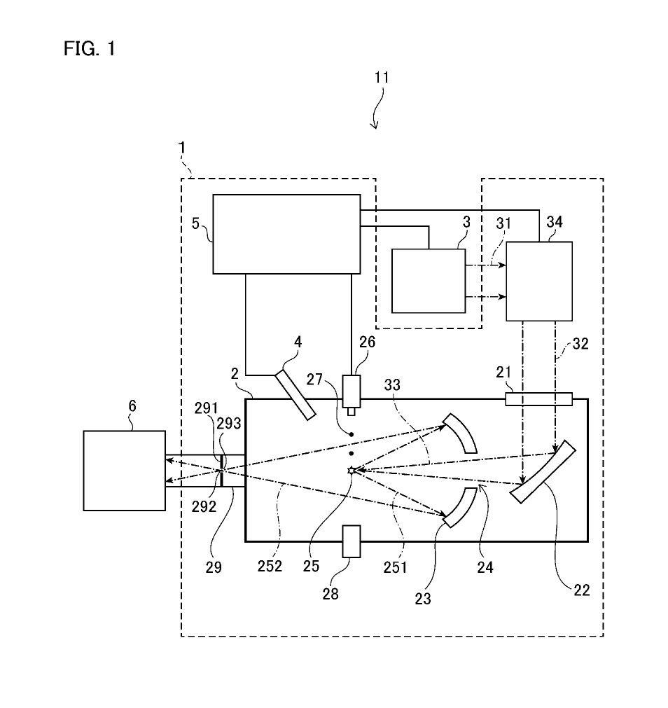

FIG. 1 schematically illustrates a configuration of an exemplary LPP type EUV light generation system. An EUV light generation device 1 may be used together with at least one laser apparatus 3. In the present application, a system including the EUV light generation device 1 and the laser apparatus 3 is referred to as an EUV light generation system 11. As illustrated in FIG. 1 and described in detail below, the EUV light generation device 1 may include a chamber 2 and a target supply unit 26. The chamber 2 may be sealed airtight. The target supply unit 26 may be mounted onto the chamber 2, for example, to pass through a wall of the chamber 2. A target substance to be supplied by the target supply unit 26 may include, but is not limited to, tin, terbium, gadolinium, lithium, xenon, or a combination of any two or more of those.

At least one through hole may be provided in the wall of the chamber 2. A window 21 may be formed in the through hole, and a pulse laser beam 32 output from the laser apparatus 3 may pass through the window 21. An EUV collector mirror 23 having, for example, a spheroidal reflecting surface may be provided inside the chamber 2. The EUV collector mirror 23 may have a first focus and a second focus. A multi-layered reflective film in which, for example, molybdenum layers and silicon layers are alternately laminated may be formed on the surface of the EUV collector mirror 23. The EUV collector mirror 23 is preferably arranged so that, for example, the first focus lies in a plasma generation region 25 and the second focus lies at an intermediate focus (IF) point 292. The EUV collector mirror 23 may have a through hole 24 formed at the center thereof so that a pulse laser beam 33 may travel through the through hole 24.

The EUV light generation device 1 may further include an EUV light generation controller 5, a target sensor 4, and the like. The target sensor 4 may have an imaging function and may be configured to detect the presence, trajectory, position, speed, and the like of a target 27.

Furthermore, the EUV light generation device 1 may include a connection unit 29 for allowing an interior of the chamber 2 to be in communication with an interior of an exposure apparatus 6. A wall 291 having an aperture 293 may be provided inside the connection unit 29. The wall 291 may be arranged so that the second focus of the EUV collector mirror 23 lies in the aperture 293 formed in the wall 291.

The EUV light generation device 1 may further include a laser beam traveling direction controller 34, a laser beam focusing mirror 22, a target collector 28 for collecting the target 27, and the like. The laser beam traveling direction controller 34 may include an optical element for defining a direction in which a laser beam travels and an actuator for adjusting a position, a posture, and the like of the optical element.

### 2.2 Operation

With reference to FIG. 1, a pulse laser beam 31 output from the laser apparatus 3 may, via the laser beam traveling direction controller 34, pass through the window 21 as a pulse laser beam 32 and enter the chamber 2. The pulse laser beam 32 may travel inside the chamber 2 along at least one laser beam path, and may be reflected by the laser beam focusing mirror 22 so as to be emitted to at least one target 27 as the pulse laser beam 33.

The target supply unit 26 may be configured to output the target 27 toward the plasma generation region 25 in the chamber 2. The target 27 may be irradiated with at least one pulse included in the pulse laser beam 33. The target 27 irradiated with the pulse laser beam is turned into plasma, and the plasma can emit radiation light 251. EUV light 252 included in the radiation light 251 may be selectively reflected by the EUV collector mirror 23. The EUV light 252 reflected by the EUV collector mirror 23 may be focused at the intermediate focus point 292 and may be output to the exposure apparatus 6. Note that a plurality of pulses included in the pulse laser beam 33 may be emitted to the single target 27.

The EUV light generation controller 5 may be configured to integrally control the EUV light generation system 11. The EUV light generation controller 5 may be configured to process image data and the like of the target 27 captured by the target sensor 4. Furthermore, the EUV light generation controller 5 may be configured to control, for example, a timing when the target 27 is output, a direction in which the target 27 is output, and the like. In addition, the EUV light generation controller 5 may be configured to control, for example, a timing when the laser apparatus 3 oscillates, a traveling direction of the pulse laser beam 32, a focusing position of the pulse laser beam 33, and the like. The various controls described above are merely examples, and other controls may be added as necessary.

### 3. EUV Light Generation Device Including Target Generation Device: Comparative Example

Next, a comparative example of the EUV light generation device including the target generation device will be described in detail with reference to the drawings. In the following description, the components similar to those illustrated in FIG. 1 will be denoted with the same reference numerals, and overlapped explanations will be omitted unless otherwise described.

3.1 Configuration

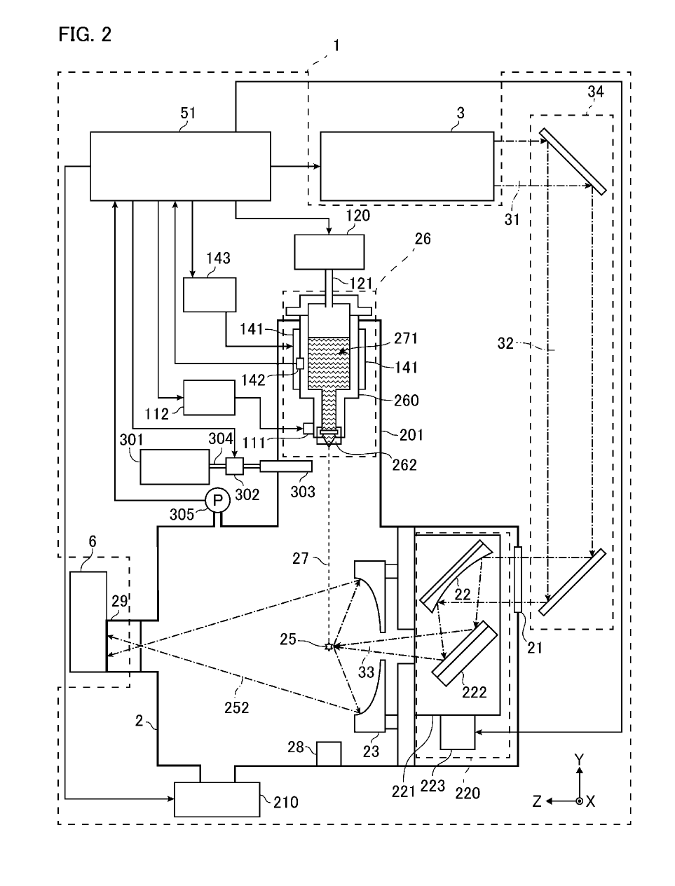

FIG. 2 is a schematic diagram illustrating an exemplary schematic configuration of an EUV light generation device according to a comparative example. As illustrated in FIG. 2, an EUV light generation device 1 may include a chamber 2, a laser beam traveling direction controller 34, and a control unit 51. A laser apparatus 3 may be added to the EUV light generation device 1.

The chamber 2 may include a target supply unit 26, a laser focusing optical system 220, an EUV collector mirror 23, a target collector 28, and a gas exhaust device 210. The target supply unit 26 may be a target generation device. The laser focusing optical system 220 may include a moving plate 221 on which a laser beam focusing mirror 22 and a high reflection mirror 222 are mounted, and a laser beam manipulator 223.

The target supply unit 26 may be provided in a sub-chamber 201 connected to the chamber 2. The target supply unit 26 may include a tank 260, a nozzle 262, a piezoelectric element 111, a temperature sensor 142, and a heater 141. The tank 260 may store a target material 271. As the target material 271, for example, tin may be exemplified. An interior of the tank 260 may communicate with a pressure regulator 120 for regulating a gas pressure via a pipe 121. Hereinafter, the gas pressure in the tank may be referred to as a tank internal pressure. The nozzle 262 may include a nozzle hole for outputting the target material 271 as a droplet-shaped target 27. The piezoelectric element 111 may be provided in the nozzle 262. The piezoelectric element 111 may be connected to a piezoelectric power supply 112, and the heater 141 may be connected to a heater power supply 143. The temperature sensor 142 and the heater 141 may be disposed in the tank. The piezoelectric power supply 112, the pressure regulator 120, the temperature sensor 142, and the heater power supply 143 may be connected to the control unit 51.

The laser focusing optical system 220 may be disposed so that a pulse laser beam 32 emitted from the laser beam traveling direction controller 34 enters the laser focusing optical system 220. The laser beam manipulator 223 may move the moving plate 221 to which the laser beam focusing mirror 22 and the high reflection mirror 222 are fixed in the X-axis direction, the Y-axis direction, and the Z-axis direction so that a laser focusing position in the chamber 2 is a position specified by the control unit 51.

The EUV light generation device 1 may include a hydrogen gas supply unit 301, a flow rate adjuster 302, a gas nozzle 303, and a gas pipe 304. In addition, the EUV light generation device 1 may further include a pressure sensor 305.

The hydrogen gas supply unit 301 may be connected to the gas nozzle 303 via the gas pipe 304. The hydrogen gas supply unit 301 may supply, for example, balance gas having a hydrogen gas concentration of about 3% to the gas pipe 304. The balance gas may contain nitrogen (N₂) gas or argon (Ar) gas.

The gas nozzle 303 may be provided in the sub-chamber 201 so that ejected hydrogen gas flows near the nozzle 262 of the target supply unit 26. The flow rate adjuster 302 may be provided in the gas pipe 304 between the hydrogen gas supply unit 301 and the gas nozzle 303.

As the pressure sensor 305, a cold cathode ionization vacuum gauge, a Pirani vacuum gauge, a capacitance manometer, and the like may be used. The gas exhaust device 210 may be used as a removal device for removing moisture in the chamber 2. The pressure sensor 305 and the flow rate adjuster 302 may be connected to the control unit 51.

3.2 Operation

At the time of maintenance of the configuration illustrated in FIG. 2 and the like, the target supply unit may be incorporated in the chamber 2. When the incorporation of the target supply unit 26 has been completed, the control unit 51 may operate the gas exhaust device 210 to exhaust atmosphere in the chamber 2. At that time, to exhaust atmospheric components, purging and exhausting the gas in the chamber 2 may be repeated. As the purge gas, nitrogen (N₂), argon (Ar), and the like may be used. As a result of the exhaust by the gas exhaust device 210, when the pressure in the chamber falls to be equal to or lower than a first predetermined pressure, the control unit 51 may start to introduce the hydrogen gas from the hydrogen gas supply unit 301 into the chamber 2. The hydrogen gas may be introduced into the chamber 2 at a low flow rate. At this time, the control unit 51 may control the flow rate adjuster 302 so that a value of the pressure sensor 305 is maintained at a second predetermined pressure. Thereafter, the control unit 51 may wait until a predetermined time has elapsed from the start of the introduction of hydrogen gas.

The control unit 51 may supply a current from the heater power supply 143 and increase the temperature of the heater 141 to heat and maintain the target material 271 formed of metal in the tank 260 to and at a predetermined temperature equal to or higher than a melting point. In addition, the control unit 51 may adjust an amount of the current supplied from the heater power supply 143 to the heater 141 based on the output from the temperature sensor 142, and accordingly, the control unit 51 may control the temperature of the target material 271 to the predetermined temperature. Note that the predetermined temperature may be, for example, a temperature within a range of 250° C. to 290° C. in a case where the target material 271 is tin.

The control unit 51 may control the tank internal pressure to a predetermined pressure using the pressure regulator 120 so that the molten target material 271 is output from the nozzle hole of the nozzle 262 at a predetermined speed. In a case where the target material 271 is metal, the target 27 discharged from the nozzle hole may be molten metal. The target material 271 discharged from the nozzle hole may have a form of a jet.

To generate the target 27 formed of the target material 271, the control unit 51 may apply a voltage with a predetermined waveform to the piezoelectric element 111 via the piezoelectric power supply 112. Vibration of the piezoelectric element 111 can propagate to the jet of the target material 271 output from the nozzle hole via the nozzle 262. The jet of the target material 271 may be divided at predetermined intervals by the vibration. Thus, the target 27 of the target material 271 can be generated. The generated target 27 may be a droplet.

The control unit 51 may output a light emission trigger to the laser apparatus 3. When the light emission trigger is input, the laser apparatus 3 may output a pulse laser beam 31. The output pulse laser beam 31 may be input to the laser focusing optical system 220 as a pulse laser beam 32 via the laser beam traveling direction controller 34 and a window 21.

The control unit 51 may control the laser beam manipulator 223 to collect the pulse laser beam 32 in the plasma generation region 25. A pulse laser beam 33 converted into convergent light by the laser beam focusing mirror 22 may be emitted to the target 27 in the plasma generation region 25. From the plasma generated by the above irradiation, EUV light can be generated. By irradiating the target 27 supplied to the plasma generation region 25 at predetermined intervals with the pulse laser beam 33, the EUV light may be periodically generated.

As described with reference to FIG. 1, after having been collected by the EUV collector mirror 23 and focused at the intermediate focus point 292, the EUV light generated from the plasma generation region 25 may be input to the exposure apparatus 6.

To stop the discharge of the target 27, the control unit 51 may stop a voltage supply to the piezoelectric element 111 and reduce the tank internal pressure to a predetermined value. The predetermined pressure may be, for example, equal to or less than 0.1 MPa.

To solidify the target material 271 in the tank 260, the control unit 51 may stop a current supply from the heater power supply 143 to the heater 141. As a result, the temperature of the target material 271 may be decreased.

The control unit 51 may stop the gas exhaust device 210 after the temperature of the target material 271 has fallen to equal to or lower than a predetermined temperature which is equal to or lower than a freezing point. The predetermined temperature may be, for example, equal to or lower than 50° C.

3.3 Problems

Here, as the target material 271, metal which is easily oxidized such as tin may be used. In general, oxidation of tin can proceed according to the following reaction formula (1).

Sn+O₂=SnO₂ (1)

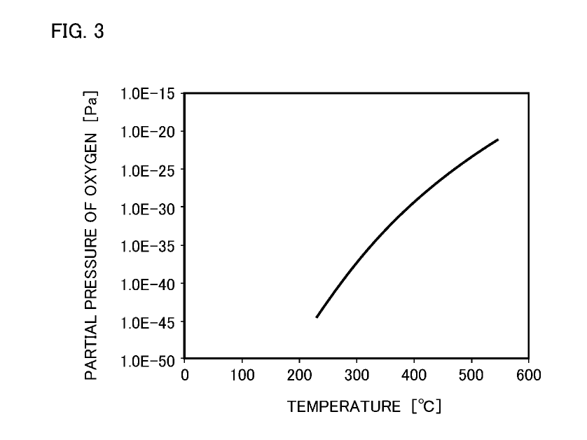

Here, a calculation result of an equilibrium partial pressure of oxygen (partial pressure of saturated oxygen) of tin in a case where it is assumed that an activity of tin (Sn) and tin oxide (SnO₂) is one is illustrated in FIG. 3. As illustrated in FIG. 3, the partial pressure of saturated oxygen of tin when a temperature of tin is in a range of 250° C. to 290° C. may be 6×10⁻⁴³ to 8×10⁻³⁹ Pa. On the other hand, the partial pressure of oxygen of the atmosphere in the chamber 2 may be 10⁻¹² Pa in a case where the inside of the chamber 2 is purged with high-purity argon gas (oxygen concentration: 0.1 ppm) and then evacuated to a high vacuum region of 10⁻⁵ Pa. The partial pressure of oxygen is larger than the partial pressure of saturated oxygen of tin by 26 digits or more. Therefore, oxidation of tin in contact with the atmosphere in the chamber 2 can proceed.

During the generation of the target 27, a surface of tin in contact with the atmosphere in the chamber 2 from the nozzle hole of the nozzle 262 is successively renewed. Therefore, the oxidation of the surface of tin would be hard to proceed. However, in a period when a high temperature of tin is maintained without generating the target 27, the oxidation of the surface of tin may proceed. The period when a high temperature of tin is maintained without generating the target 27 may include, for example, a period when the temperature of tin is increased, a standby period of the discharge of the target 27 after the temperature has been increased, and a period when the temperature of tin is decreased after the discharge of the target 27 has been stopped.

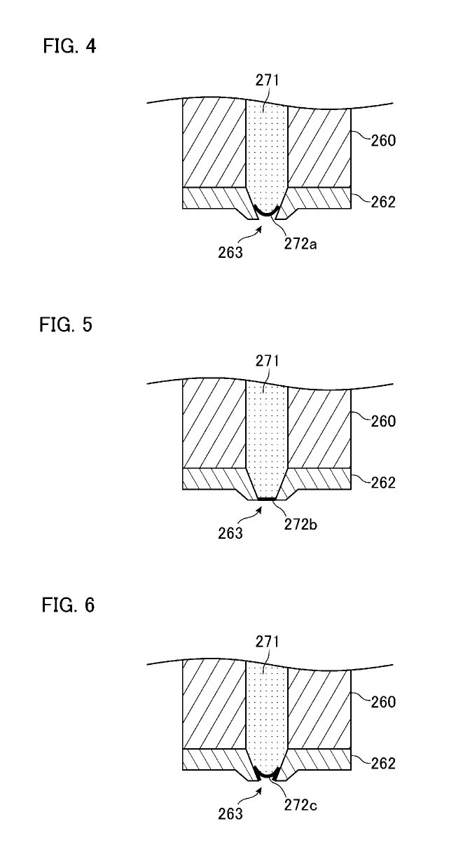

When the oxidation of tin in contact with the atmosphere in the chamber 2 proceeds in the vicinity of the nozzle hole 263, a film of tin oxide which is a solid can be formed. The tin oxide can cause clogging in the nozzle hole. Even if clogging is not caused, tin oxide may be attached to an outer periphery of the nozzle hole. Here, an example of tin oxide formed in the vicinity of the nozzle hole 263 will be described with reference to FIGS. 4 to 6.

FIG. 4 is a diagram illustrating exemplary tin oxide formed on a surface of tin during the temperature increasing period after the target supply unit 26 has been incorporated in the chamber 2. When the temperature of tin is increased, there are cases where tin is drawn into the nozzle hole 263 due to contraction caused by previous temperature decrease. In that case, as illustrated in FIG. 4, the surface of tin is oxidized inside the nozzle hole 263, and a tin oxide film 272a may be formed.

FIG. 5 is a diagram illustrating exemplary tin oxide formed on the surface of tin in the standby period after the temperature of tin has been increased. A volume of tin molten by increasing the temperature can increase. Therefore, the nozzle hole 263 can be filled with molten tin. In such a state, a tin oxide film 272b can be formed on the surface of tin exposed from the nozzle hole 263. Depending on a relationship between the pressure in the tank and the pressure in the chamber and a generation stop condition of the target 27, the surface of tin exposed from the nozzle hole 263 can be hemispherical rather than flat.

FIG. 6 is a diagram illustrating exemplary tin oxide formed on the surface of tin in the period when the temperature of tin is decreased. As described above, at the time of solidification, tin can be drawn into the nozzle hole 263 due to the contraction. At this time, if the tin oxide film 272b is formed on the surface of tin as illustrated in FIG. 5, a tin oxide film 272c can be formed from an inner wall surface of the nozzle hole 263 to the surface of tin.

Furthermore, in a case where hydrogen gas is introduced into the chamber 2 as described above, hydrogen and oxygen may react with each other in the chamber 2 to generate water. As a result, the partial pressure of oxygen in the chamber 2 may be decreased. However, some oxygen may remain in the chamber without reacting with hydrogen. When oxygen remains, the tin oxide films 272a to 272c can be formed as described above.

As described above, tin oxide can be formed in the vicinity of the nozzle hole 263 during the period when the temperature is increased, in the standby period, and the period when the temperature is decreased. When the tin oxide is attached to the outer periphery of the nozzle hole 263 in this way, an orbit of the target 27 discharged from the nozzle hole 263 can change. When the change in the orbit is large, a disadvantage may be caused such that the target 27 does not pass through the plasma generation region 25 and is not irradiated with the pulse laser beam 33. Therefore, in the following embodiments, a target generation device and an EUV light generation device which can reduce oxides of the target material 271 formed in the vicinity of the nozzle hole are exemplified.

### 4. First Embodiment

Next, a target generation device and an EUV light generation device according to a first embodiment will be described in detail with reference to the drawings. In the following description, the components similar to those described above are denoted with the same reference numerals, and overlapped explanations will be omitted unless otherwise described.

4.1 Configuration

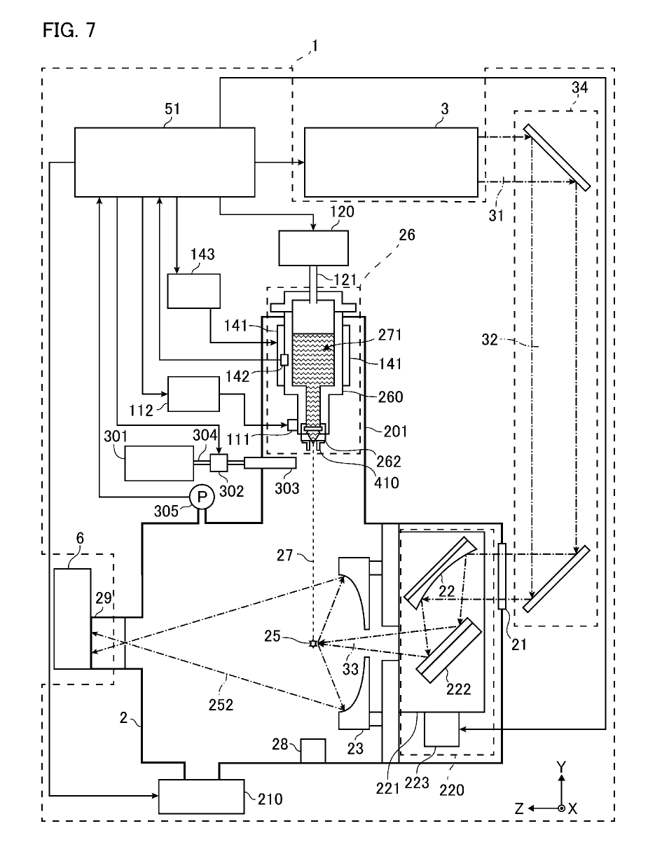

FIG. 7 is a schematic diagram illustrating an exemplary schematic configuration of an EUV light generation device including a target generation device according to the present embodiment. As illustrated in FIG. 7, an EUV light generation device 1 according to the present embodiment may be different from the EUV light generation device 1 illustrated in FIG. 2 in that the target generation device may include a cylindrical member 410.

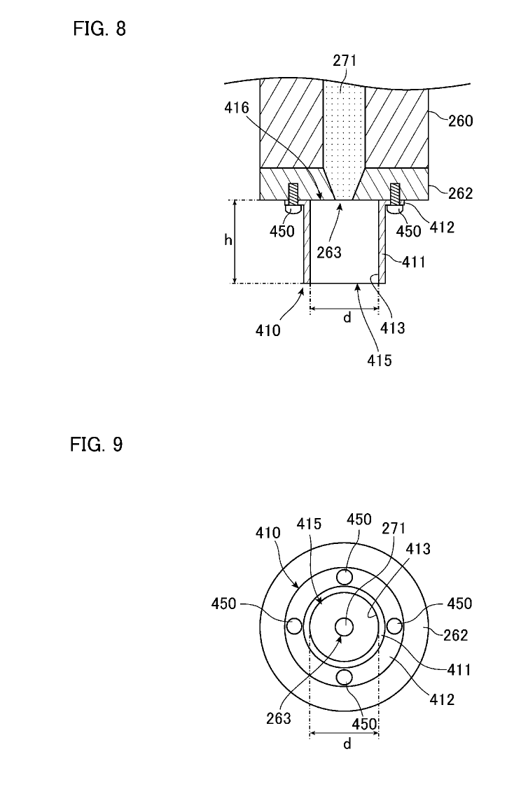

FIG. 8 is a cross sectional diagram illustrating an exemplary schematic configuration of a portion including the vicinity of a front end of a nozzle 262 in FIG. 7. FIG. 9 is a schematic diagram illustrating an exemplary schematic configuration of the portion including the vicinity of the front end of the nozzle 262 in a case of viewing the nozzle 262 toward a nozzle hole 263. As illustrated in FIGS. 8 and 9, the cylindrical member 410 may be attached around a portion of the nozzle 262 where the nozzle hole 263 is formed. The cylindrical member 410 may include a cylindrical main body 411 and a flange portion 412. The cylindrical main body 411 may have a cylindrical shape with a constant wall thickness. Both ends of the cylindrical main body 411 may be opened. An opening at one end may be an opening 415, and an opening at the other end may be an opening 416. The flange portion 412 may be connected to the other end of the cylindrical main body 411. A plurality of through holes may be formed in the flange portion 412, and a fixing member 450 may be inserted through each through hole to a hole formed in the nozzle 262. With the plurality of fixing members 450, the cylindrical member 410 may be attached to the nozzle 262 to surround the nozzle hole 263. As the fixing members 450, for example, bolts may be used. A fixing member other than bolts may be used. In a state where the cylindrical member 410 is attached to the nozzle 262 with these fixing members 450, the opening 416 may be closed with the nozzle 262. In this state, when viewing the side of the opening 416 from the side of the opening 415, the nozzle hole 263 may be exposed from the opening 416. An inner diameter d of the cylindrical member 410 illustrated in FIGS. 8 and 9 may be, for example, equal to or more than one mm and equal to or less than 50 mm. Furthermore, a height h may be equal to or more than three mm and equal to or less than 300 mm. For example, the inner diameter d may be 10 mm, and the height h may be 16 mm.

The cylindrical main body 411 may be formed of a substance having standard free energy of formation of oxide smaller than that of molten metal to be the target 27 discharged from the nozzle hole 263 of the nozzle 262. Therefore, the substance may be exposed from an inner wall surface 413 of the cylindrical member 410. Furthermore, the cylindrical main body 411 may be formed of a dense substance.

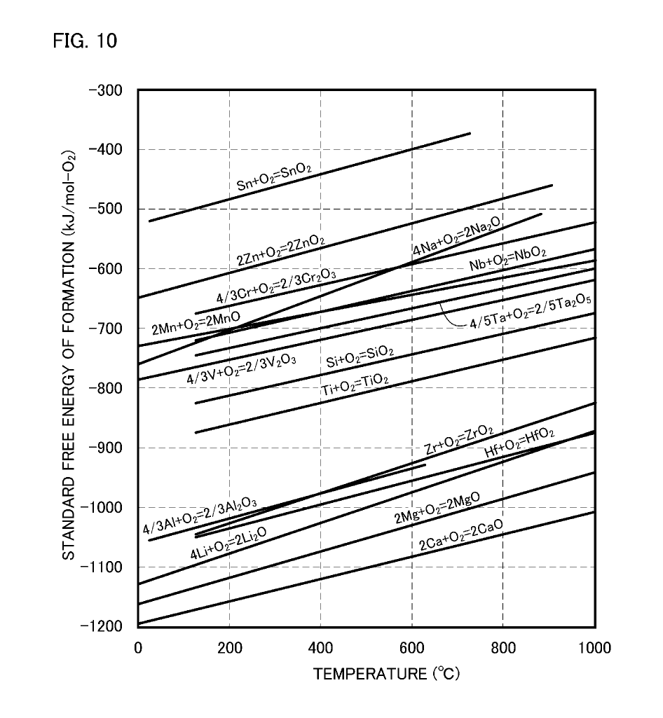

FIG. 10 is a conceptual diagram illustrating an exemplary relationship between standard free energy of formation and a temperature of a substance. The standard free energy of formation means an amount of a change in free energy per mol of oxygen when an oxide is produced from a single substance. Details of this diagram are described in Yasutoshi Saito, Toru Atake, and Toshio Maruyama (compiled and translated) (1986), “Oxidation of metal at high temperature” (Uchida Rokakuho), and Osamu Izumi (1987), “Modern metallurgy, Material 5, Non-ferrous metal” (The Japan Institute of Metals and Materials). As illustrated in FIG. 10, in a case where the material of the target 27 is, for example, tin, calcium, magnesium, lithium, hafnium, zirconium, aluminum, titanium, silicon, tantalum, vanadium, niobium, sodium, manganese, chromium, and zinc may be exemplified as a substance having standard free energy of formation of oxide smaller than the molten tin. Oxidation of these substances can proceed according to the following reaction formulas (2) to (16).

2Ca+O₂=2CaO (2)

2Mg+O₂=2MgO (3)

4Li+O₂=2Li₂O (4)

Hf+O₂=HfO₂ (5)

Zr+O₂=ZrO₂ (6)

4/3Al+O₂=2/3Al₂O₃ (7)

Ti+O₂=TiO₂ (8)

Si+O₂=SiO₂ (9)

4/5Ta+O₂=2/5Ta₂O₅ (10)

4/3V+O₂=2/3V₂O₃ (11)

Nb+O₂=NbO₂ (12)

4Na+O₂=2Na₂O (13)

2Mn+O₂=2MnO (14)

4/3Cr+O₂=2/3Cr₂O₃ (15)

2Zn+O₂=2ZnO (16)

In a case where the material of the target 27 is, for example, tin, the cylindrical main body 411 may be formed of at least one metal selected from among the above substances. Furthermore, in a case where the material of the target 27 is, for example, tin, a temperature of the molten tin may be set to 250 to 290 degrees Celsius. In this case, the temperature of the nozzle 262 may be substantially the same as that of the molten tin. Therefore, it is preferable that the cylindrical main body 411 is formed of at least one kind of metal selected from among hafnium, zirconium, titanium, tantalum, vanadium and niobium of the substances described above. Melting points of the substances are higher than the temperature of the molten tin, and the cylindrical main body 411 is formed of these substances. Thus, the cylindrical main body 411 can be prevented from being molten by heat conducted from the nozzle 262.

The flange portion 412 may be formed of a substance having standard free energy of formation of oxide smaller than that of the molten metal. Furthermore, the fixing member 450 may be formed of a substance having standard free energy of formation of oxide smaller than that of the molten metal. Even when the flange portion 412 and the fixing member 450 are formed of a substance having standard free energy of formation of oxide smaller than that of the molten metal, it is not necessary for the cylindrical main body 411, the flange portion 412, and the fixing member 450 to be formed of the same substance.

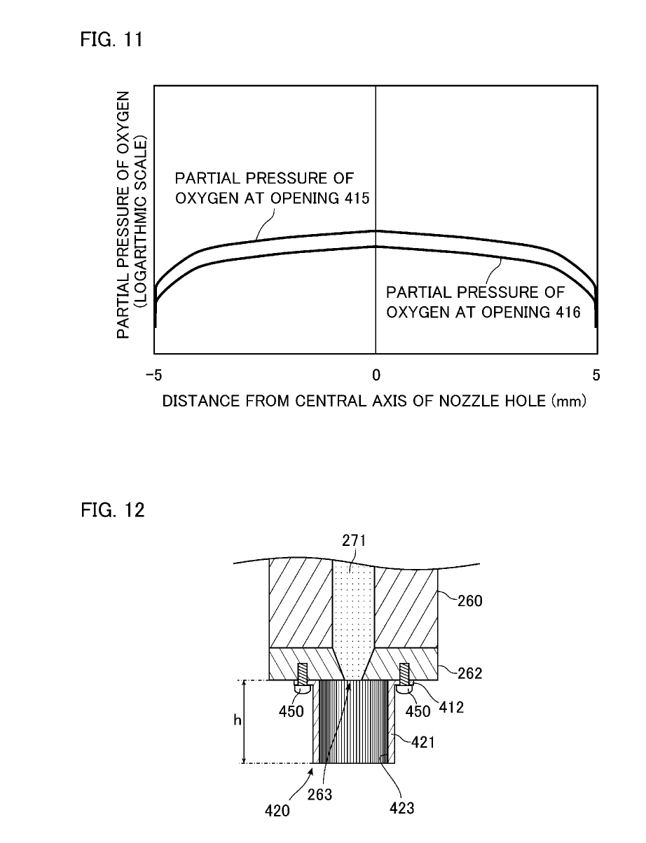

FIG. 11 is a conceptual diagram illustrating estimated partial pressures of oxygen at the opening 415 at one end and the opening 416 at the other end of the cylindrical main body 411 illustrated in FIG. 8. A vertical axis indicates logarithms. In FIG. 11, a case is illustrated where an inner diameter d of the cylindrical member 410 is 10 mm and a height h is 16 mm. As illustrated in FIG. 11, at both the opening 415 and the opening 416, the partial pressure of oxygen may be decreased from the vicinity of the central axis of the cylindrical main body 411 toward the inner wall surface 413 of the cylindrical main body 411. In addition, the partial pressure of oxygen may be more decreased at the opening 416 than at the opening 415. This can be considered because the inner wall surface 413 of the cylindrical main body 411 traps oxygen prior to the molten metal to be the target 27 exposed from the nozzle hole 263. Accordingly, the cylindrical member 410 can be understood as an oxygen trapping member.

4.2 Operation

In the target generation device having the configuration illustrated in FIGS. 7 to 9, when the target 27 formed of molten metal is discharged, the discharged target 27 may pass through the through hole of the cylindrical main body 411 and may travel on a target orbit. As described above, the target 27 may be irradiated with the pulse laser beam 33 in the plasma generation region 25, and EUV light may be generated.

4.3 Action and Effect

In the present embodiment, the cylindrical member 410 is attached to the nozzle 262 to surround the nozzle hole 263, and a substance having standard free energy of formation of oxide smaller than that of the molten metal to be the target 27 may be exposed on at least a part of the inner wall surface 413. Thus, this substance can trap oxygen prior to the molten metal. Therefore, the partial pressure of oxygen in the vicinity of the nozzle hole 263 can be lowered, and the oxidation of the molten metal can be suppressed in the temperature increasing period, the standby period, the temperature decreasing period, and the like. In this way, formation of molten metal oxide in the vicinity of the nozzle hole 263 can be suppressed.

Since the oxidation of the molten metal can be suppressed in this way, a change in the orbit of the target 27 discharged from the nozzle hole 263 can be suppressed. Therefore, it can be suppressed that the target 27 does not pass through the plasma generation region 25, and a disadvantage such that the pulse laser beam 33 is not emitted to the target 27 can be prevented. Therefore, the EUV light generation device 1 according to the present embodiment can stably generate the EUV light.

### 5. Second Embodiment

Next, a target generation device and an EUV light generation device 1 according to a second embodiment will be described in detail with reference to the drawings. In the following description, the components similar to those described above are denoted with the same reference numerals, and overlapped explanations will be omitted unless otherwise described.

5.1 Configuration

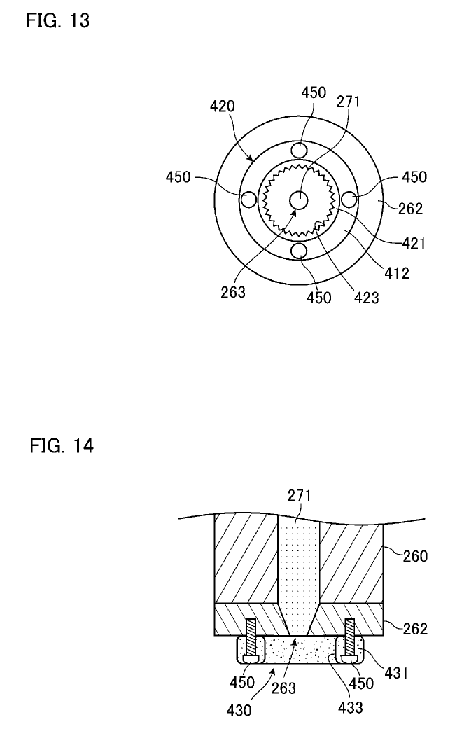

FIG. 12 is a cross sectional diagram illustrating an exemplary schematic configuration of a portion including a vicinity of a front end of a nozzle 262 according to the present embodiment. FIG. 13 is a schematic diagram illustrating an exemplary schematic configuration of the portion including the vicinity of the front end of the nozzle 262 in a case of viewing the nozzle 262 toward a nozzle hole 263. As illustrated in FIGS. 12 and 13, the target generation device according to the present embodiment is different from the target generation device according to the first embodiment in that a cylindrical member 420 may be attached to the nozzle 262 instead of the cylindrical member 410 in the first embodiment. Therefore, the EUV light generation device 1 according to the present embodiment is different from the EUV light generation device 1 illustrated in FIG. 7 in that the cylindrical member 420 may be included instead of the cylindrical member 410 in FIG. 7.

The cylindrical member 420 may include a cylindrical main body 421 instead of the cylindrical main body 411. The cylindrical main body 421 is different from the cylindrical main body 411 in that an inner wall surface 423 may be uneven. Therefore, an area of the inner wall surface 423 of the cylindrical member 420 may be larger than an area of the inner wall surface 413 of the cylindrical member 410 according to the first embodiment. In the cylindrical member 420, the inner wall surface 423 may be uneven by forming a plurality of grooves in the inner wall surface 413 along the longitudinal direction of the cylindrical main body 421. Although the shapes of the grooves are different from those in FIGS. 12 and 13, the inner wall surface 423 may be uneven by forming a single or a plurality of spiral grooves in the inner wall surface 413, and the inner wall surface 423 may be uneven by applying sandblasting and the like on the inner wall surface 413. That is, shapes of irregularities formed on the inner wall surface 413 are not particularly limited.

In the present embodiment, similarly to the cylindrical main body 411 according to the first embodiment, the cylindrical main body 421 may be configured of a substance having standard free energy of formation of oxide smaller than that of molten metal to be the target 27 discharged from the nozzle hole 263 of the nozzle 262. Therefore, in the present embodiment, similarly to the first embodiment, the substance may be exposed on the inner wall surface 423 of the cylindrical member 420, and the cylindrical member 420 can be understood as an oxygen trapping member.

5.2 Action and Effect

In the present embodiment, the inner wall surface 423 of the cylindrical member 420 where a substance having standard free energy of formation of oxide smaller than that of the molten metal is exposed may be formed to be uneven. Therefore, an area of the inner wall surface 423 may be larger than the area of the inner wall surface 413 of the cylindrical member 410 according to the first embodiment. Therefore, the cylindrical member 420 may trap oxygen more efficiently than the cylindrical member according to the first embodiment by the inner wall surface 423. Accordingly, the partial pressure of oxygen in the vicinity of the nozzle hole 263 can be more decreased than the first embodiment. Therefore, oxidation of the molten metal can be further suppressed, and formation of molten metal oxide in the vicinity of the nozzle hole 263 can be further suppressed.

### 6. Third Embodiment

Next, a target generation device and an EUV light generation device 1 according to a third embodiment will be described in detail with reference to the drawings. In the following description, the components similar to those described above are denoted with the same reference numerals, and overlapped explanations will be omitted unless otherwise described.

6.1 Configuration

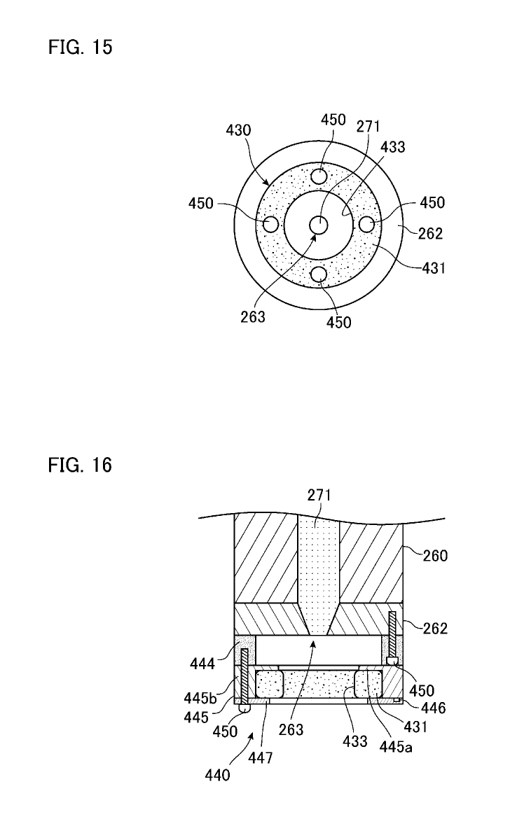

FIG. 14 is a cross sectional diagram illustrating an exemplary schematic configuration of a portion including a vicinity of a front end of a nozzle 262 according to the present embodiment. FIG. 15 is a schematic diagram illustrating an exemplary schematic configuration of the portion including the vicinity of the front end of the nozzle 262 in a case of viewing the nozzle 262 toward a nozzle hole 263. As illustrated in FIGS. 14 and 15, the target generation device according to the present embodiment is different from the target generation device according to the first embodiment in that a cylindrical member 430 may be attached to the nozzle 262 instead of the cylindrical member 410 in the first embodiment. Therefore, the EUV light generation device 1 according to the present embodiment is different from the EUV light generation device 1 illustrated in FIG. 7 in that the cylindrical member 430 may be included instead of the cylindrical member 410 in FIG. 7.

The cylindrical member 430 may include a cylindrical main body 431 instead of the cylindrical main body 411 and may not include a flange portion. A plurality of through holes is formed in the cylindrical main body 431, and fixing members 450 may be inserted into a plurality of holes formed in the nozzle 262 through these through holes. Similarly to the first embodiment, the cylindrical member 430 may be attached to the nozzle 262 to surround the nozzle hole 263. The cylindrical main body 431 is different from the cylindrical main body 411 according to the first embodiment in that the cylindrical main body 431 is a porous body through which oxygen molecules pass. Examples of a form of the cylindrical main body 431 which is a porous body may include a mesh-like shape in which a large number of holes are formed in a dense substance, a sponge-like shape in which a large number of bubbles are formed as in a metal foam and the holes are connected to each other, and a coupled-particle-like shape in which a large number of metal particles of which powders may be compacted are coupled and air gaps are formed between the particles.

In the present embodiment, similarly to the cylindrical main body 411 according to the first embodiment, the cylindrical main body 431 may be configured of a substance having standard free energy of formation of oxide smaller than that of molten metal to be a target 27 discharged from the nozzle hole 263 of the nozzle 262. Therefore, in the present embodiment, similarly to the first embodiment, the substance may be exposed from the inner wall surface 433 of the cylindrical member 430, and the cylindrical member 430 can be understood as an oxygen trapping member.

6.2 Action and Effect

In the present embodiment, since the cylindrical member 430 formed of the above substances may be a porous body through which oxygen molecules can pass, the cylindrical member 430 can trap the oxygen molecules in the cylindrical member 430. That is, the cylindrical member 430 can increase a surface area of a substance which can trap oxygen, and the cylindrical member 430 can more effectively trap oxygen than the cylindrical member 410 according to the first embodiment. Accordingly, a partial pressure of oxygen in the vicinity of the nozzle hole 263 can be more decreased than the first embodiment. Therefore, oxidation of the molten metal can be further suppressed, and formation of molten metal oxide in the vicinity of the nozzle hole 263 can be further suppressed.

### 7. Fourth Embodiment

Next, a target generation device and an EUV light generation device 1 according to a fourth embodiment will be described in detail with reference to the drawings. In the following description, the components similar to those described above are denoted with the same reference numerals, and overlapped explanations will be omitted unless otherwise described.

7.1 Configuration

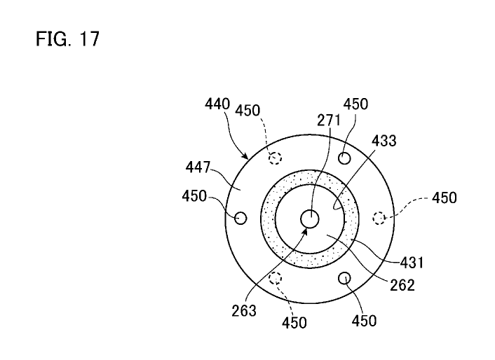

FIG. 16 is a cross sectional diagram illustrating an exemplary schematic configuration of a portion including a vicinity of a front end of a nozzle 262 according to the present embodiment. FIG. 17 is a schematic diagram illustrating an exemplary schematic configuration of the portion including the vicinity of the front end of the nozzle 262 in a case of viewing the nozzle 262 toward a nozzle hole 263. As illustrated in FIGS. 16 and 17, the target generation device according to the present embodiment is different from the target generation device according to the first embodiment in that a cylindrical member 440 may be attached to the nozzle 262 instead of the cylindrical member 410 in the first embodiment. Therefore, the EUV light generation device 1 according to the present embodiment is different from the EUV light generation device 1 illustrated in FIG. 7 in that the cylindrical member 440 may be included instead of the cylindrical member 410 in FIG. 7.

The cylindrical member 440 may mainly include a cylindrical main body 431 similar to the cylindrical main body 431 according to the third embodiment, a thermal insulating member 444, a heater 445, a holding member 447, and a temperature sensor 446.

The thermal insulating member 444 has a cylindrical shape, and a plurality of through holes may be formed in the thermal insulating member 444. By inserting fixing members 450 through the plurality of through holes to holes formed in the nozzle 262, the thermal insulating member 444 may be fixed to the nozzle 262 to surround the nozzle hole 263. The thermal insulating member 444 may be formed of a material having a thermal conductivity lower than that of the nozzle 262. As such a material, for example, ceramic may be exemplified.

The heater 445 may be disposed on the thermal insulating member 444. The heater 445 may include a flat plate portion 445a which may be formed into a flat plate-like and ring shape and a side wall portion 445b which may be formed in a cylindrical shape connected to the flat plate portion 445a. An outer diameter of the flat plate portion 445a of the heater 445 may be approximately equal to an outer diameter of the thermal insulating member 444, and an inner diameter of the flat plate portion 445a may be approximately equal to an inner diameter of the thermal insulating member 444. One surface of the flat plate portion 445a may be disposed in contact with the thermal insulating member 444. An outer diameter of the side wall portion 445b of the heater 445 may be approximately equal to an outer diameter of the thermal insulating member 444, and an inner diameter of the side wall portion 445b may be larger than the inner diameter of the thermal insulating member 444 and may be approximately equal to an outer diameter of the cylindrical main body 431. The heater 445 may be connected to a heater power supply which is not shown, and the heater power supply may be connected to a control unit.

The cylindrical main body 431 may be disposed in contact with the other surface of the flat plate portion 445a and an inner wall surface of the side wall portion 445b of the heater 445. An inner diameter of the cylindrical main body 431 may be smaller than the inner diameter of the thermal insulating member 444 and the inner diameter of the flat plate portion 445a of the heater 445.

The holding member 447 may be disposed on the side wall portion 445b of the heater 445 and on a side opposite to the thermal insulating member 444 of the cylindrical main body portion 431. The holding member 447 may be formed in a flat plate-like and ring shape. An outer diameter of the holding member 447 may be approximately equal to the outer diameter of the side wall portion 445b of the heater 445, and an inner diameter of the holding member 447 may be larger than the inner diameter of the cylindrical main body 431 and smaller than the outer diameter of the cylindrical main body 431. A plurality of through holes may be formed in the holding member 447 and the heater 445. By inserting the fixing members 450 through the plurality of through holes to the hole formed in the thermal insulating member 444, the holding member 447 may be fixed to the thermal insulating member 444 via the heater 445. In this state, the holding member 447 may press and fix the cylindrical main body 431 against the thermal insulating member 444. The temperature sensor 446 may be disposed between the holding member 447 and the cylindrical main body 431 and may be electrically connected to the control unit 51 illustrated in FIG. 7.

7.2 Operation

A temperature of the heater 445 may be increased by a current supplied from a heater power supply. The temperature of the heater 445 may be higher than a temperature of a tank 260. The temperature of the heater 445 may be, for example, equal to or higher than 500 degrees Celsius to equal to or lower than 800 degrees Celsius, and it is preferable to set to approximately 700 degrees Celsius. It is preferable that the temperature of the heater 445 is set to a temperature at which the cylindrical main body 431 does not melt. The cylindrical main body 431 can be heated by the increase in the temperature of the heater 445. At this time, the thermal insulating member 444 can suppress conduction of the heat of the heater 445 to a target material via the nozzle 262.

7.3 Action and Effect

In the present embodiment, the cylindrical main body 431 may be heated by the heater 445. An increase in the temperature of the cylindrical main body 431 may accelerate an oxidation rate of a substance having standard free energy of formation of oxide smaller than that of the molten metal to be the target 27. Therefore, the cylindrical member 440 can trap oxygen earlier than the cylindrical member 410 according to the first embodiment. Therefore, the partial pressure of oxygen in the vicinity of the nozzle hole 263 can be reduced earlier than that according to the first embodiment. Therefore, in the present embodiment, oxidation of the molten metal can be suppressed at an earlier stage, and formation of the molten metal oxide in the vicinity of the nozzle hole 263 can be suppressed at an earlier stage.

The present invention has been described by using the embodiments as examples. However, the present invention is not limited to these embodiments.

For example, in the above embodiments, it has been described that the cylindrical main body may be formed of a substance having standard free energy of formation of oxide smaller than that of the molten metal to be the target 27. However, the cylindrical main body may have the substance exposed from a part of the inner wall surface.

Furthermore, in the first to third embodiments, the cylindrical members 410 to 430 do not need to have the thermal insulating member. However, in the first to third embodiments, the cylindrical members 410 to 430 may each have the thermal insulating member corresponding to the thermal insulating member 444 according to the fourth embodiment between the respective cylindrical main bodies 411 to 431 and the nozzles 262. In this case, the thermal insulating member can suppress the conduction of the heat of the tank 260 to the cylindrical main bodies 411 to 431 via the nozzle 262. Therefore, as the cylindrical main bodies 411 to 431, a material having a melting point lower than the temperature of the molten metal to be the target 27 can be used.

In addition, the cylindrical main body according to the fourth embodiment may be similar to the cylindrical main body 431 according to the third embodiment. However, the cylindrical main body 431 according to the fourth embodiment may be formed of a dense substance similarly to the cylindrical main body 411 according to the first embodiment or the cylindrical main body 421 according to the second embodiment.

The above description is presented by way of examples, but not necessarily. Accordingly, various modifications to the embodiments according to the present disclosure will become apparent to those skilled in the art without departing from the scope of the appended claims.

The terms used in the specification and the appended claims should be interpreted as “non-limiting” terms. For example, the terms “include” or “be included” should be interpreted as “including the stated elements but not limited to the stated elements”. The term “have” should be interpreted as “having the stated elements but not limited to the stated elements”. Furthermore, the indefinite article “one” (a/an) used in the specification and the appended claims should be interpreted as “at least one” or “one or more”.

### REFERENCE SIGNS LIST

2 . . . chamber
3 . . . laser apparatus
25 . . . plasma generation region
26 . . . target supply unit
27 . . . target
34 . . . laser beam traveling direction controller
51 . . . control unit
260 . . . tank
262 . . . nozzle
263 . . . nozzle hole
410, 420, 430, 440 . . . cylindrical member
411, 421, 431 . . . cylindrical main body
444 . . . thermal insulating member
445 . . . heater
447 . . . holding member

What is claimed is:

1. A target generation device comprising:
a nozzle including a nozzle hole for discharging a target formed of molten metal in a chamber; and
a cylindrical member attached to the nozzle to surround the nozzle hole and having a substance, with standard free energy of formation of oxide smaller than that of the molten metal, which is exposed on at least a part of an inner wall surface.

2. The target generation device according to claim 1, wherein
the substance has a cylindrical shape.

3. The target generation device according to claim 1, wherein
a portion where the substance of the cylindrical member is exposed on the inner wall surface is uneven.

4. The target generation device according to claim 1, wherein
the substance is a porous body through which oxygen molecules passes.

5. The target generation device according to claim 1, wherein
the cylindrical member includes a thermal insulating member in a nozzle-side portion.

6. The target generation device according to claim 1, wherein
the cylindrical member includes a heater for heating the substance.

7. The target generation device according to claim 6, wherein
the cylindrical member includes a thermal insulating member between the heater and the nozzle.

8. The target generation device according to claim 1, wherein
the cylindrical member is fixed to the nozzle with a fixing member, and
the fixing member is formed of a substance having standard free energy of formation of oxide smaller than that of the molten metal.

9. The target generation device according to claim 1, wherein
the molten metal is tin, and the substance having the standard free energy of formation of oxide smaller than that of the molten metal is at least one kind of metal selected from among calcium, magnesium, lithium, hafnium, zirconium, aluminum, titanium, silicon, vanadium, tantalum, niobium, sodium, manganese, chromium, and zinc.

10. The target generation device according to claim 6, wherein
the substance having the standard free energy of formation of oxide smaller than that of the molten metal is at least one kind of metal selected from among hafnium, zirconium, titanium, vanadium, tantalum, and niobium.

11. An extreme ultraviolet light generation device comprising:
a nozzle including a nozzle hole for discharging a target formed of molten metal in a chamber;
a cylindrical member attached to the nozzle to surround the nozzle hole and have a substance, with standard free energy of formation of oxide smaller than that of the molten metal, which is exposed on at least a part of an inner wall surface;
a laser apparatus configured to irradiate the target output from the nozzle hole with a laser beam; and
a focusing mirror configured to collect and output extreme ultraviolet light emitted from plasma of the target generated by being irradiated with the laser beam.
